(19) United States
(12) Patent Application Publication
(10) Pub. No.: US 2025/0091014 A1
(43) Pub. Date: Mar. 20, 2025

(54) METHOD FOR PRODUCING AN INORGANIC FILTRATION MEDIUM THROUGH INTERMESHING AND OBTAINED MEMBRANE

(71) Applicant: TECHNOLOGIES AVANCEES ET MEMBRANES INDUSTRIELLES, Nyons (FR)

(72) Inventors: Philippe LESCOCHE, Nyons (FR); Jérôme ANQUETIL, Nyons (FR)

(73) Assignee: TECHNOLOGIES AVANCEES ET MEMBRANES INDUSTRIELLES, Nyons (FR)

(21) Appl. No.: 18/725,920

(22) PCT Filed: Dec. 26, 2022
(86) PCT No.: PCT/FR2022/052504

§ 371 Date: Jul. 1, 2024

(30) Foreign Application Priority Data
Dec. 30, 2021 (FR) FR2114668

(51) Int. Cl. B01D 63/06; B01D 69/10; B33Y 10/00; B33Y 80/00

(52) U.S. Cl. CPC B01D 63/066; B01D 69/108; B33Y 10/00; B33Y 80/00; B01D 2315/10

(57) ABSTRACT

The invention concerns a method for producing a porous monolithic inorganic support (1) using a 3D printing machine comprising at least one extrusion head (6) mounted moveably in space. The method consists of:
Driving the extrusion head according to a numerical trajectory so that:
   for an overlapping path, the material being deposited partially overlaps at least one edge of a previously deposited material deposition, by an overlapping material part presented in its thickness and having a thickness strictly less than the nominal height (e) so as to avoid spaces between the rounded edges of the material deposition being deposited and those of the material deposition previously deposited,
   for a crossing path, the material being deposited intersects at least one previously deposited material deposition with a complete overlap of said previously deposited material deposition, by an overlapping material part presented in its thickness and having a thickness strictly less than the nominal height (e).

### TECHNICAL FIELD

The present invention concerns a method for manufacturing a porous monolithic inorganic support, which can especially be used to obtain a filtration membrane, and in particular a tangential filtration membrane. More precisely, the porous support is prepared by a technique involving the addition of material.

### PRIOR ART

The filtration membrane constitutes a selective barrier and allows, under the action of a transfer force, certain components of the liquid medium to be treated to pass through or be stopped. The passage or stopping of the components can result from their size in relation to the size of the pores of the membrane which then behaves like a filter. Depending on the pore size, these techniques are called microfiltration, ultrafiltration or nanofiltration.

A membrane consists of a porous support on which one or more separation layers are deposited. Conventionally, the support is first shaped by extrusion. The support is then sintered to achieve the required solidity, while maintaining an open and interconnected porous texture. This method requires rectilinear channels to be obtained, inside which the separating layer(s) are then deposited and sintered. The membrane thus produced therefore undergoes at least two sintering operations. The organic binders added during the preparation of the paste, before its extrusion, burn off completely when the support is sintered.

In application FR 3,006,606, the applicant described the preparation of a filtration membrane whose porous support is produced by an additive technique, by repeated deposition of a continuous bed of powder followed by localized consolidation according to a predetermined pattern. This technique makes it possible to prepare mechanically resistant filtration membranes suitable for use in tangential filtration. However, this technique has the disadvantage of requiring the powder to be adjusted to allow to flow perfectly during the deposition of the powder bed. In addition, this technique requires the removal of the unconsolidated powder, in order to possibly also recycle it, which can prove to be difficult, time consuming and expensive, especially when said unconsolidated powder is present in the non-rectilinear channels of the porous support.

By patent applications WO2020/109715 and WO2020/109716, the applicant has also proposed novel processes for the preparation of a porous support which do not have the disadvantages of the prior art, and, in particular, which are quick and easy to implement, which make it possible to obtain a mechanically resistant porous support whose shape, and especially that of the non-rectilinear channels, is easily varied. The porous support obtained is homogeneous, mechanically resistant and has a porosity suitable for use in filtration, i.e., a porosity comprised between 10 and 60% and which is open and interconnected with a mean pore diameter ranging from 0.5 μm to 50 μm.

For this purpose, the methods use a 3D printing machine comprising an extrusion head mounted movably in space relative to and above a fixed horizontal plate. An inorganic composition emerges from the extrusion head in the form of a ribbon of material or bead making it possible to build, from a 3D digital model, a manipulable three-dimensional green structure to form the monolithic porous inorganic support(s). The manipulable three-dimensional green structure is then subjected to a sintering step.

As explained in these patent applications, the manipulable three-dimensional green structure is obtained from the superposition of strata, each corresponding to a set of continuous or discontinuous beads, juxtaposed or non-juxtaposed, which are extruded at the same altitude according to the 3D digital model. The different strata can be stacked along the vertical axis in different ways.

In the state of the art, a method for manufacturing a 3D object by means of modelling is also known from patent application WO 2020/109716, by depositing a molten filament in which an overlapping path is made. Similarly, patent application US 2017/165917 describes a method of manufacturing a 3D object by means of modelling, using two controlled material deposition nozzles especially to create a crossing between the two beads of material.

The applicant has thus envisaged producing the strata by vertical stacks of deposits of contiguous beads of material c as illustrated in FIG. 1A. The applicant found that after the sintering operation (FIG. 1B), such a structure contained material voids v which could have a larger pore size and which could reduce the mechanical strength of the porous support.

The applicant has also envisaged producing the strata by depositing beads of material c arranged in a staggered manner as illustrated in FIG. 1C. This solution provides nothing with regard to the elimination of residual voids v between the beads of material. After the sintering operation (FIG. 1D), the structure still has internal material voids v. In addition, this solution deteriorates the quality of the lateral surfaces since every other stratum has a gap leading to the collapse of the material deposition in the upper stratum.

### DISCLOSURE OF THE INVENTION

The object of the invention is precisely to remedy the disadvantages of the state of the art by proposing a new method for the manufacture of a porous monolithic inorganic support, designed to avoid creating material voids liable to reduce the mechanical strength of the porous support.

Another object of the invention is to propose a method of manufacturing a three-dimensional structure, designed to be able to control the dimensions of this three-dimensional structure and, in particular, the profile of the walls of this three-dimensional structure.

Another object of the invention is to propose a method for manufacturing a three-dimensional structure provided with at least one channel for circulating a fluid medium to be treated, possessing a wall suitable for depositing separation layers.

Another object of the invention is to propose a method of manufacturing a three-dimensional structure provided with at least one channel for circulating a fluid medium to be treated, possessing a wall having an uninterrupted succession of rounded reliefs generating variations in the passage section of the channel, while avoiding the appearance of prohibitive load losses.

To achieve these goals, the invention concerns a method for the production of at least one porous monolithic inorganic support having at least one channel for circulating the fluid to be treated and having a porosity comprised between 10% and 60% and a mean pore diameter ranging from 0.5 μm to 50 μm, by means of a 3D printing machine comprising at least one extrusion head mounted moveably in space above a fixed horizontal plate, by being successively moved with a nominal height along a predefined numerical trajectory to effect superimposed material depositions each having a nominal width and a defined thickness between a lower surface and an upper surface, said 3D printing machine allowing depositing material in the form of:
a bead with rounded edges so as to create rounded perimeter reliefs participating in the generation of turbulence on the wall of at least one circulation channel,
a composition to build, on said horizontal plate, from the predefined numerical trajectory, walls of a manipulable three-dimensional green structure to form the monolithic porous inorganic support(s), the method consisting of:
For a wall whose width is greater than the nominal width of the material deposition, to break down the numerical trajectory exclusively into overlapping paths and crossing paths;
To supply the extrusion head of the 3D printing machine with a composition,
To drive the extrusion head according to the numerical trajectory so that:
   for an overlapping path, the material being deposited partially overlaps at least one edge of a previously deposited material deposition, by an overlapping material part presented in its thickness and having a thickness strictly less than the nominal height so as to avoid, in the inner part of the manipulable three-dimensional green structure, spaces between the rounded edges of the material deposition being deposited and those of the material deposition previously deposited,
   for a crossing path, the material being deposited intersects at least one previously deposited material deposition with a complete overlap of said previously deposited material deposition, by an overlapping material part presented in its thickness and having a thickness strictly less than the nominal height so as to avoid, in the inner part of the manipulable three-dimensional green structure, spaces between the rounded edges of the material deposition being deposited and those of the material deposition previously deposited.

According to an advantageous characteristic of embodiment, the extrusion head is mounted moveably along the predefined numerical trajectory in order to carry out a succession of turns each corresponding to the path travelled in order to find the same position in the horizontal plane with an elevation corresponding to a nominal height.

According to another advantageous embodiment characteristic, the extrusion head is driven so that, over at least one turn, the extrusion head rises at least once by an intermediate height which is a fraction of the nominal height.

According to another characteristic of the invention, the extrusion head is driven so that, over at least one turn, the extrusion head is positioned at different points of the path, rising at each point by a height increment, the sum of which corresponds to the nominal height.

Advantageously, the extrusion head is driven so that by the succession of turns, the extrusion head rises to build the manipulable three-dimensional green structure in accordance with the 3D digital model, following a trajectory with an uninterrupted material deposition from the beginning to the end of the construction of the manipulable three-dimensional green structure.

According to an advantageous characteristic, the extrusion head is driven so that, during each turn, the extrusion head is offset in the horizontal plane so that the material being deposited partially overlaps an edge of a deposition of previously deposited material.

For a crossing path, the extrusion head is driven to reduce the quantity of material deposited to produce the overlapping material part having a thickness strictly less than the nominal height.

For a path with the same overlap, the extrusion head is driven to keep the flow rate of deposited material constant.

For an overlapping path, the extrusion head is driven to adjust its position in the plane to define the degree of overlap of the overlapping material part on the previously deposited material deposition.

For an overlapping path, the flow rate of the extrusion head is adjusted according to the degree of overlap of the overlapping material part on the previously deposited material deposition.

Typically, the extrusion head is mounted moveably along the predefined numerical trajectory in order to carry out superimposed material depositions in strata each rising by a nominal height.

According to another characteristic of the invention, the extrusion head is driven so as to provide, in the manipulable three-dimensional green structure, at least one channel for circulating a fluid medium to be treated, possessing a wall having a succession of rounded reliefs generating variations in the passage section of the channel, these rounded reliefs being formed by the part of material situated opposite the overlapping material part.

According to another characteristic, the extrusion parameters are adjusted and the extrusion head is configured so that the part of material located opposite the overlapping material part has a rounded edge.

Conventionally, the manipulable three-dimensional green structure is placed in a heat treatment furnace in order to carry out a sintering operation.

Another object of the invention is to propose a method for the preparation of a tangential filtration membrane comprising the manufacture of a porous monolithic inorganic support in which is provided at least one channel for circulating the fluid medium to be treated, followed, after the sintering of said support, by a step of creating at least one separating layer on the walls of the channel or channels.

Another object of the invention is to provide a porous monolithic inorganic support produced according to the method according to the invention and possessing an outer surface having a succession of rounded-perimeter reliefs and a circulation channel whose walls have rounded-perimeter reliefs participating in generating turbulence.

Another object of the invention is to propose a tangential filtration membrane comprising a porous monolithic inorganic support provided with at least one channel for circulating the fluid medium to be treated, whose wall with rounded perimeter reliefs is coated with at least one separating layer.

### BRIEF DESCRIPTION OF THE DRAWINGS

FIG. 1A is a sectional view of a wall produced by the vertical stacking of deposits of beads of material showing voids.

FIG. 1B is a view of the wall illustrated in FIG. 1A showing the persistence of voids.

FIG. 1C is a sectional view of a wall produced by the vertical staggered stacking of deposits of beads of material showing voids.

FIG. 1D is a view of the wall illustrated in FIG. 1C after the sintering operation and showing the persistence of voids.

FIG. 2A is a schematic view of a 3D printing machine making it possible to implement the invention.

FIG. 2B is a perspective view of an example of an embodiment of a manipulable three-dimensional green structure.

FIG. 3 is a schematic top view showing the material deposition in conventional mode to produce a tubular wall of width equal to the nominal width of a material deposition.

FIG. 3A is a sectional view taken substantially along lines A-A of FIG. 3 showing successive material depositions in conventional mode for producing a tubular wall.

FIG. 4 is a schematic top view showing the material deposition in vase mode to produce a tubular wall of width equal to the nominal width of a material deposition.

FIG. 4A is a sectional view taken substantially along lines A-A of FIG. 4 showing the successive material depositions in vase mode to produce a tubular wall.

FIG. 5 is a schematic top view showing the principle according to the invention of the material depositions for a path with overlapping of the extrusion head.

FIG. 5A is a sectional view taken substantially along lines A-A of FIG. 5 showing the overlap of the material depositions for a path with overlapping of the extrusion head.

FIG. 6 is a schematic top view showing material depositions for a path with crossing of the extrusion head.

FIG. 6A is a sectional view taken substantially along lines A-A of FIG. 6 showing the overlap, in accordance with the invention, of the material depositions for a path with crossing of the extrusion head.

FIG. 6B is a sectional view taken substantially along lines B-B of FIG. 6 showing the overlap, in accordance with the invention, of the material depositions for a path with crossing of the extrusion head.

FIG. 7 is a schematic top view showing a principle step for material deposition in sequential vase mode to produce a tubular wall with a width greater than the nominal width of a material deposition.

FIG. 7A is a sectional view taken substantially along lines A-A of FIG. 7 showing a principle step for material deposition in sequential vase mode to produce a tubular wall of greater width than the nominal width of a material deposition.

FIG. 7B is a schematic top view showing the course of the material deposition in sequential vase mode to produce a tubular wall of greater width than the nominal width of a material deposition.

FIG. 8 is a schematic top view showing another principle step for material deposition in sequential vase mode to produce a tubular wall with a width greater than the nominal width of a material deposition.

FIG. 8A is a sectional view taken substantially along lines A-A of FIG. 8 showing another principle step for material deposition in sequential vase mode to produce a tubular wall of greater width than the nominal width of a material deposition.

FIG. 8B is a schematic top view showing the course of the material deposition in sequential vase mode to produce a tubular wall of greater width than the nominal width of a material deposition.

FIG. 8C is a view showing another principle step for material deposition in sequential vase mode to produce a tubular wall of greater width than the nominal width of a material deposition.

FIG. 9 is a schematic top view showing a principle step for material deposition in continuous vase mode to produce a tubular wall with a width greater than the nominal width of a material deposition.

FIG. 9A is a sectional view taken substantially along lines A-A of FIG. 9 showing a principle step for material deposition in continuous vase mode to produce a tubular wall of greater width than the nominal width of a material deposition.

FIG. 9B is a schematic top view showing the course of the material deposition in continuous vase mode to produce a tubular wall of greater width than the nominal width of a material deposition.

FIG. 10 is a schematic top view showing another principle step for material deposition in continuous vase mode to produce a tubular wall of greater width than the nominal width of a material deposition.

FIG. 10A is a sectional view taken substantially along lines A-A of FIG. 10 showing another principle step for material deposition in continuous vase mode to produce a tubular wall of greater width than the nominal width of a material deposition.

FIG. 10B is a schematic top view showing the course of the material deposition in continuous vase mode to produce a tubular wall of greater width than the nominal width of a material deposition.

FIG. 10C is a view showing another principle step for material deposition in continuous vase mode to produce a tubular wall of greater width than the nominal width of a material deposition.

FIG. 11 is a schematic illustrating an example of an extrusion head course for the method called “sequential vase mode” and for the method called “continuous vase mode”.

FIG. 12A is a top view showing another example of a wall delimiting two contiguous channels and having a width greater than twice the nominal width of a material deposition.

FIG. 12B is a sectional view taken substantially along lines B-B of FIG. 12A.

FIG. 13A is a sectional view showing the material deposition carried out according to a method of the prior art, for a path with crossing, before passing over the crossing.

FIG. 13B is a sectional view showing the material deposition carried out according to a method of the prior art, for a path with crossing, when passing over the crossing.

FIG. 13C is a sectional view showing the material deposition carried out according to a method of the prior art, for a path with crossing, after passing over the crossing.

FIG. 13D is a sectional view showing the material deposition carried out according to a method of the prior art, for a path with crossing, and superimposing the material deposition previously carried out.

FIG. 13E is a sectional view showing the material deposition made according to a method of the prior art, for a path with crossing, superimposing the material deposition previously made and showing the creation of voids at the crossing of the material depositions.

FIG. 14 is a sectional view showing an example of an embodiment according to the invention with material depositions produced in superposition by strata in accordance with the principle of the invention.

FIG. 15 is an oblique cross-sectional image of a porous monolithic inorganic support with eight filtration channels showing the absence of voids.

FIG. 16 is a cross-sectional image of a tangential filtration membrane comprising an eight-channel porous monolithic inorganic support whose channel walls with rounded perimeter reliefs are coated with a separating layer.

### DESCRIPTION OF THE EMBODIMENTS

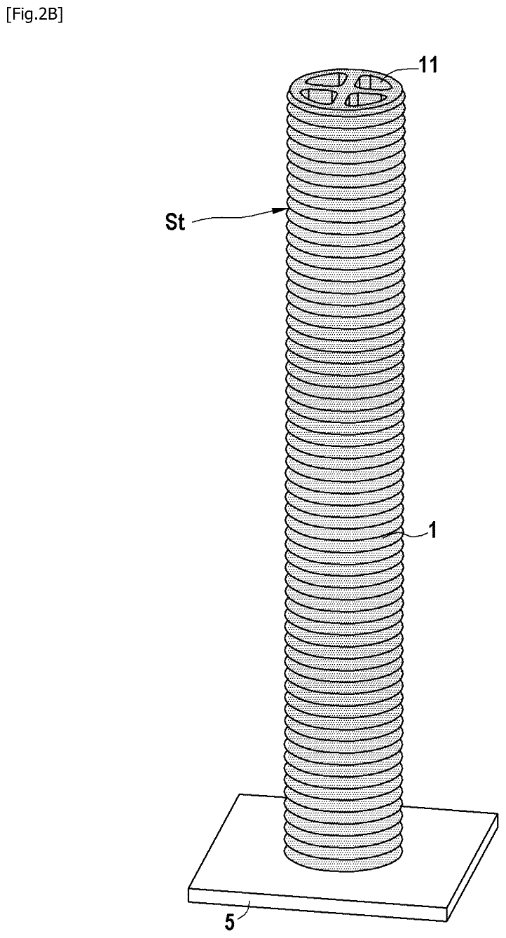

The object of the invention concerns the manufacture of a porous monolithic inorganic support 1 (FIG. 2B) intended to constitute an element for separating by tangential flow a liquid medium to be treated into a filtrate (or permeate) and a retentate, commonly known as a tangential filtration membrane.

In numerous applications, such porous supports have a tubular geometry and comprise at least one channel or path for circulation of the fluid to be filtered, provided with at least one separating layer. These circulation channels have an inlet and an outlet. In general, the inlet of the circulation channels is positioned at one end of the porous support, this end acting as an inlet zone for the fluid medium to be treated and their outlet is positioned at another end of the porous support acting as an outlet zone for the retentate. The inlet zone and the outlet zone are connected by a continuous peripheral zone at which the permeate is recovered.

In other applications, the porous supports may be in the form of a block, for example of parallelepiped shape, in which at least one circulation channel or path for the fluid to be filtered is arranged, provided with at least one separating layer. The permeate is recovered at the periphery of the block or by means of a collection circuit arranged in the block. In the examples illustrated, the porous support has a tubular geometry, but it is clear that the object of the invention can be applied to porous supports of any shape.

When the porosity (the mean pore diameter) of the sintered support is suited to the fluid medium to be treated (filtration threshold), said sintered support can be used directly in filtration and is designated by auto-membrane or homogeneous membrane.

When the porosity of the sintered support is not suited to the fluid medium to be treated (pores too large in size compared to the necessary filtration threshold), the walls of the circulation channel or channels are then continuously covered by at least one separating layer which ensures the filtration of the fluid medium to be treated. The at least one separating layer is porous and has a mean pore diameter smaller than the mean pore diameter of the support. The separating layer can either be deposited directly on the porous support (in the case of a monolayer separating layer), or on an intermediate layer with a smaller mean pore diameter, itself deposited directly on the porous support (in the case of a multilayer separating layer). Thus, part of the fluid medium to be filtered passes through the separating layer or layers and the porous support, so that this treated part of the fluid, called permeate, flows through the outer peripheral surface of the porous support. The separating layers delimit the surface of the filtration membrane intended to be in contact with the fluid to be treated and in contact with which the fluid to be treated circulates.

The porosity of the monolithic inorganic support 1 is open, i.e. it forms a network of pores interconnected in three dimensions, which allows the fluid filtered by the separating layer(s) to pass through the porous support and be recovered at the periphery. The permeate is therefore recovered on the peripheral surface of the porous support.

The porous monolithic inorganic support 1 has a mean pore diameter ranging from 0.5 μm to 50 μm. The porosity of the porous monolithic inorganic support 1 is comprised between 10 and 60%, preferably between 20 and 50%.

Mean pore diameter means the d50 value of a volume distribution for which 50% of the total pore volume corresponds to the volume of pores with a diameter smaller than this d50. The volume distribution is the curve (analytical function) representing the frequencies of the pore volumes as a function of their diameter. The d50 corresponds to the median separating into two equal parts the area under the frequency curve obtained by mercury penetration. In particular, the technique described in standard ISO 15901-1:2005 can be used for the mercury penetration measurement technique.

The porosity of the support, which corresponds to the total volume of the interconnected voids (pores) present in the material under consideration, is a physical quantity comprised between 0 and 1 or between 0% and 100%. It conditions the flow and retention capacities of said porous body. In order for the material to be used in filtration, the total interconnected open porosity must be at least 10% for a satisfactory flow rate of filtrate through the support, and at most 60% in order to guarantee a suitable mechanical strength of the porous support.

The porosity of a porous body can be measured by determining the volume of a liquid contained in said porous body by weighing said material before and after prolonged residence in said liquid (water or other solvent). Knowing the respective densities of the material in question and of the liquid used, the mass difference, converted to volume, is directly representative of the pore volume and therefore of the total open porosity of the porous body.

Other techniques can be used to accurately measure the total open porosity of a porous body, including:
porosimetry by mercury intrusion (ISO standard 15901-1 mentioned above): Injected under pressure, mercury fills the accessible pores at the pressures used, and the volume of mercury injected then corresponds to the pore volume;
small angle x-ray scattering: This technique, which uses either neutron radiation or X-rays, gives access to physical quantities averaged over the entire sample. The measurement consists in the analysis of the angular distribution of the intensity scattered by the sample,
the analysis of 2D images obtained by microscopy,
the analysis of 3D images obtained by X-ray tomography.

In addition, the porous monolithic inorganic support 1 has a mechanical strength suitable for use in tangential filtration. More precisely, the porous monolithic inorganic support 1 withstands an internal pressure of at least 10 bars without bursting, and preferably at least 30 bars without bursting and advantageously at least 50 bars without bursting. According to the invention, a bursting pressure corresponds to the pressure at which a support whose porosity has previously been blocked (with a heat-fusible material such as paraffin) bursts under the effect of an internal excess pressure in relation to the pressure outside support, this excess pressure being applied in the channels with water, the pressure outside the support being atmospheric pressure.

As can be seen more precisely in FIG. 2A, the porous monolithic inorganic support 1 according to the invention is prepared by sintering a manipulable three-dimensional green structure 2, which is constructed in accordance with a 3D digital model M by superimposing material depositions 3 of composition 4 in the general sense. Material depositions are made using a three-dimensional printing machine especially comprising a horizontal plate 5, possibly removable, above which at least one extrusion head 6 is arranged.

The term “three-dimensional green structure” 2 is understood to mean a three-dimensional structure obtained from the superposition of deposits of a composition 4 and which has not yet undergone sintering. The shape and the dimensions of this green structure are determined level by level, by the 3D digital model M, as will be explained in detail in the remainder of the description. The 3D digital model M is determined by computer design software, in order to construct the three-dimensional green structure 2.

This three-dimensional green structure 2 is described as “manipulable” because it does not deform under its own weight, and can even have slope, thanks to accelerated consolidation which gives it a mechanical rigidity stable over time, as will be explained hereinafter. This three-dimensional green structure 2 can thus be detached from the horizontal plate 5 in order to be moved without deformation or breaking, especially to subsequently undergo a heat treatment operation necessary to obtain a monolithic porous support according to the invention.

The extrusion head 6 of the three-dimensional printing machine is supported by a moving mechanism (not shown in the figures), such as a robot, enabling it to be moved along at least three axes (x, y and z). Thus, the extrusion head 6 can be moved in a horizontal plane (x and y axes) and vertically (z axis), thanks to the moving mechanism which is driven by a computer R of all types known in themselves. This computer R controls the movements of the moving system and consequently of the extrusion head 6, along a predetermined trajectory as a function of the 3D digital model M from which the three-dimensional green structure 2 is produced which makes it possible to obtain the porous monolithic inorganic support 1 after a heat treatment operation.

The extrusion head 6 comprises an inlet for the composition 4 (not shown in the figures). As shown in the figures, the extrusion head 6 also comprises an extrusion nozzle comprising a calibrated flow orifice 8 from which the composition 4 emerges. The extrusion head 6 and consequently also the extrusion nozzle with its flow orifice 8 which is integral with the extrusion head 6 are movable according to said 3D digital model M. According to the method of the invention, the composition 4 is introduced into the extrusion head 6 of the machine via an inlet in order to supply the flow orifice 8. A mechanical action can be applied to introduce the composition 4 into the head 6 via this inlet.

In the context of the invention, “mechanical action” is understood to mean the application of pressure by any known technical means, such as, for example, a piston, a pump or an extrusion screw. This step can be carried out in the usual manner by a person skilled in the art and will not be detailed here. The material leaves the flow orifice 8 by means of a certain pressure higher than atmospheric pressure. This results in a force which is exerted vertically on the material from top to bottom at the time of extrusion and which contributes to the crushing of the material between the extrusion nozzle and the underlying hardened material.

The flow orifice 8 is placed opposite and close to the horizontal plate 5. The flow orifice 8 is movable, vertically (i.e., along the z axis) and horizontally (i.e., along the x and y axes), with respect to the horizontal plate 5 which is fixed. The vertical and/or horizontal movement of the flow orifice 8 with respect to the fixed horizontal plate 5 allows the construction according to the digital 3D model M of the manipulable three-dimensional green structure 2 resting on the horizontal plate 5 following the extrusion of a bead of material through the flow orifice 8.

According to the embodiment illustrated in the figures, the extrusion head 6 is provided with a flow orifice 8 of circular cross-section. When the flow orifice 8 is of circular cross-section, its diameter advantageously ranges from 0.1 mm to 10 mm, preferably from 0.1 mm to 1 mm and preferentially from 0.2 to 0.8 mm.

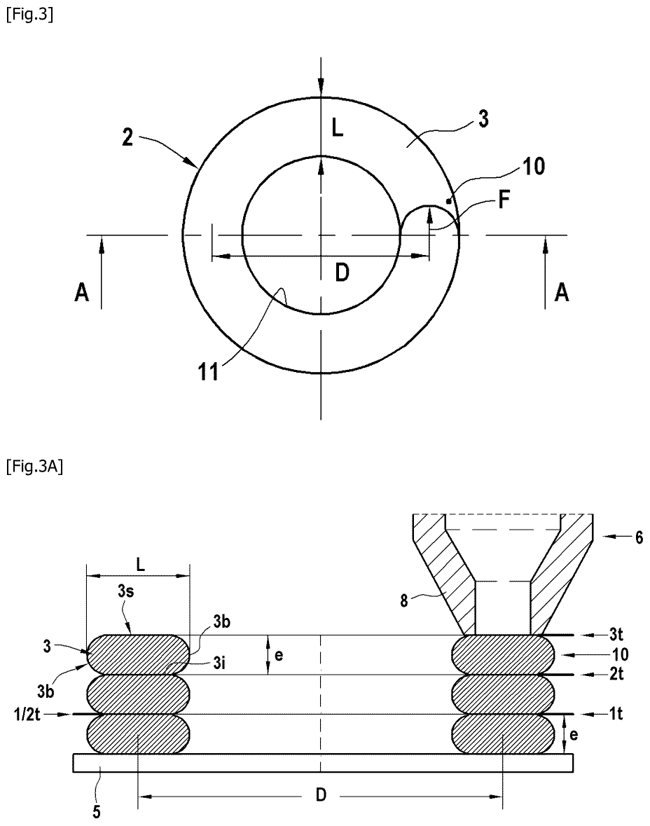

It is recalled that at a predefined extrusion rate E (determined, for example, by the rotation speed of the extrusion screw), a predefined movement speed F of the extrusion head 6 and a nominal movement height e of the extrusion head 6 correspond to a material deposition 3 with a nominal width L so that L=f(E, F, e). The material deposition 3 has a cross-section with a nominal height e defined between a substantially flat upper surface 3s and a substantially flat lower surface 3i connected to each other on either side by two edges 3b of rounded shape (FIGS. 3 and 3A). The nominal width L of the material deposition 3 can therefore be adjusted or modified as a function of the movement speed F and/or the extrusion rate of the extrusion head 6.

The extrusion head 6 is supplied with a composition 4, for example in the form of a paste as described, for example, in document PCT/FR2019/052807, or in the form of a filament or granules as described in document PCT/FR2019/052808. Advantageously, the composition 4 is an inorganic composition typically of ceramic and/or metallic nature.

The ceramic composition is composed of a powdery solid inorganic phase and a matrix.

The powdery solid inorganic phase of the ceramic composition comprises one or more solid inorganic materials, each in the form of particles with a mean diameter comprised between 0.1 μm and 150 μm.

The notion of mean diameter is associated with that of particle distribution. Indeed, the particles of a powder are rarely of single size, or monodisperse, and a powder is therefore most often characterized by a particle size distribution. The mean diameter is then the mean of a particle size distribution. The distribution can be represented in different ways, such as, for example, a frequency or cumulative distribution. Some measurement techniques directly give a distribution based on number (microscopy) or mass (sieving). The mean diameter is a measure of central tendency.

Among the most commonly used central tendencies are mode, median and mean. The mode is the most common diameter in a distribution: It corresponds to the maximum of the frequency curve. The median represents the value from which the total frequency of the values above and below is the same (i.e., the same number or total volume of particles below the median is found as above).

The mean must be calculated and determines the point where the moments of the distribution are equal. For a normal distribution, the mode, mean, and median coincide, while they differ for a non-normal distribution.

The mean particle diameter of an inorganic powder can be measured especially by:
laser light diffraction for particles ranging from 3 mm to approximately 0.1 μm;
sedimentation/centrifugation;
dynamic light scattering (DLS) for particles ranging from 0.5 μm to 2 nm;
analysis of images obtained by microscopy;
small angle X-ray scattering.

Granularity of the powdery solid inorganic phase is understood to mean the dimensions of the particles constituting the powdery solid inorganic phase. The granularity is characterized by the concept of mean diameter which is described above.

Most often, the ceramic composition comprises, as powdery ceramic material(s), alone or as a mixture, an oxide and/or a nitride and/or a carbide. Examples of oxides which may be suitable in the context of the invention especially include metal oxides, and, in particular, titanium oxide, zirconium oxide, aluminium oxide and magnesium oxide; titanium oxide is preferred. Examples of carbides especially include metal carbides, and in particular silicon carbide. Examples of nitrides that can be used especially include titanium nitride, aluminium nitride and boron nitride. According to a preferred embodiment, the ceramic composition comprises at least one metal oxide as powdery inorganic material, and preferably titanium oxide.

In the context of the invention, the ceramic composition has a suitable rheology in terms of plasticity for its extrusion through the extrusion head 6.

According to a first embodiment, the matrix of the ceramic composition comprises one or more solvents. The solvent(s) may be aqueous or organic. Examples include water, ethanol or acetone.

In addition, the matrix of the ceramic composition comprises one or more organic additives. Advantageously, these organic additives are soluble in the solvent or solvents of the matrix. The organic additive or additives suitable for the purposes of the invention may be chosen by way of non-limiting examples from:
binders, for example, among cellulose ethers such as hydroxyethylcellulose which is a polymer, gum Arabic which is a polysaccharide, or polyethylene glycol (PEG);
lubricants and plasticizers, for example among glycerol or stearic acid;
thickeners and gelling agents, for example among xanthan gum or agar-agar which is a galactose polymer.

The mass content of powdery inorganic material(s) in the ceramic composition can range from 50 to 90%, preferentially between 80 and 85% by weight, relative to the total weight of the ceramic composition.

The total mass content of matrix in the ceramic composition can range from 10 to 50% by weight, preferably from 15 to 20% by weight, relative to the total weight of the composition.

This ceramic composition is not a powder but rather a paste. It is possible to adjust the rheology of this ceramic composition by means of the granularity of the powdery solid inorganic phase, and/or by means of the nature of the organic additives when they are present and/or by means of their respective proportions. Indeed, for example, the use of a matrix comprising one or more organic additives soluble in one or more solvents comprised in the matrix makes it possible to modify the rheology of the ceramic composition.

According to a second embodiment, the ceramic composition comprises a matrix consisting of one or more hot melt polymers. The matrix is organic in nature and solid at room temperature.

“Hot melt polymer” means a polymer that softens under the effect of heat.

Examples of hot-melt polymers that may be suitable in the context of the invention include, alone or as a mixture in the matrix, the following polymers or family of polymers, optionally functionalized: polylactic acid (PLA), polyvinyl alcohol (PVA), acrylonitrile butadiene styrene (ABS), polypropylene (PP), polyethylene, polyethylene terephthalate (PET), thermoplastic polyurethane (TPU), polyolefins, thermoplastic elastomers (TPE), polyolefin-based elastomers (TPE-O) and polycarbonate.

The mass content of powdery inorganic material(s) in the ceramic composition can range from 40 to 95%, preferably between 70 and 90% by weight, relative to the total weight of the ceramic composition.

In the context of the invention, the ceramic composition, preferably in the form of granules, is preheated upstream so that the hot-melt polymer or polymers soften so that the ceramic composition can be pressurized upstream of the flow orifice 8. In the usual way, the extrusion head 6 is heated to soften the hot-melt polymer(s) then allowing the ceramic composition to be extruded. The temperature of the extrusion head 6 and of the flow orifice 8 can be adjusted as a function of the hot-melt polymer or polymers present in the ceramic composition.

Moreover, within the scope of the invention, it is possible to adjust the rheology of the ceramic composition by means of its temperature in the extrusion head and/or the granularity of the powdery solid inorganic phase, and/or by means of the nature of the hot-melt polymer or polymers and/or by means of their proportions.

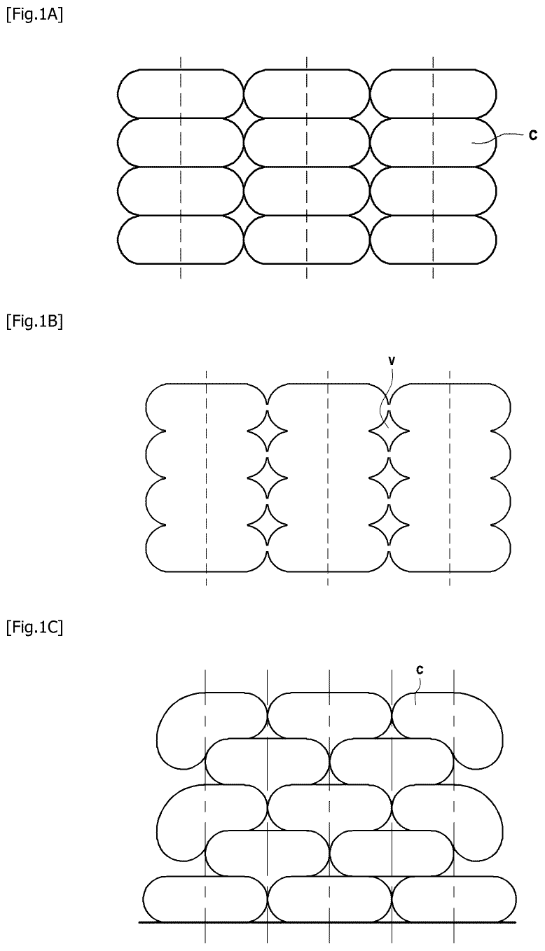

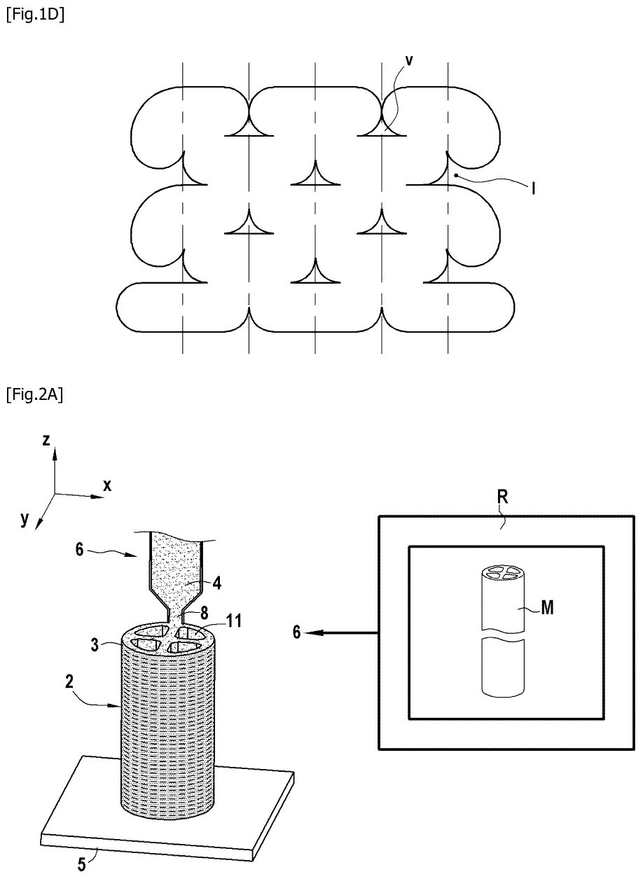

In accordance with the invention, the method according to the invention aims to break down the numerical trajectory into paths so as to avoid, in the inner part of the manipulable three-dimensional green structure, the creation of spaces between the rounded edges of the current material deposition and those of the previously deposited material deposition. As explained in FIGS. 1A and 1C, the deposition of beads of material made in a contiguous manner according to the state of the art leads to the creation of material voids that persist after sintering and are likely to reduce the mechanical strength of the porous monolithic inorganic support.

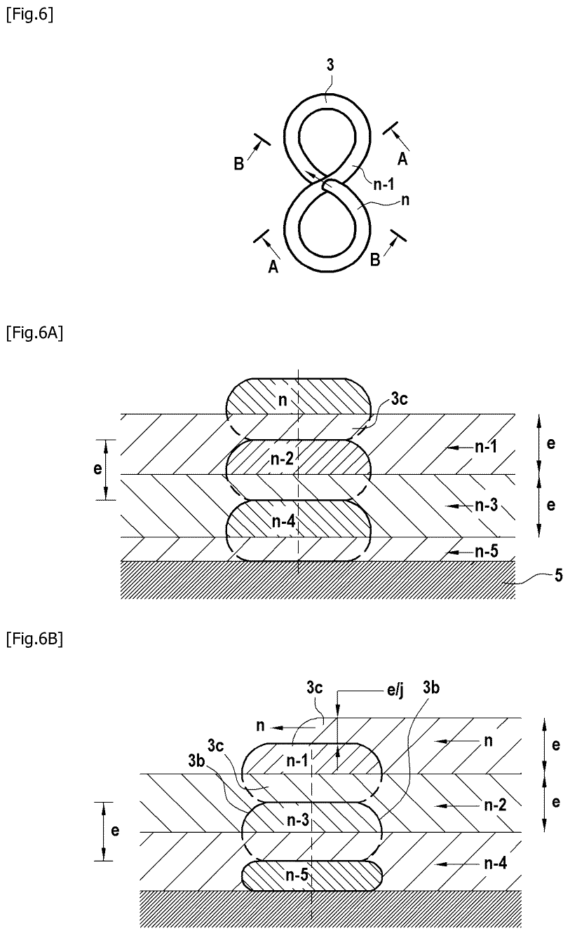

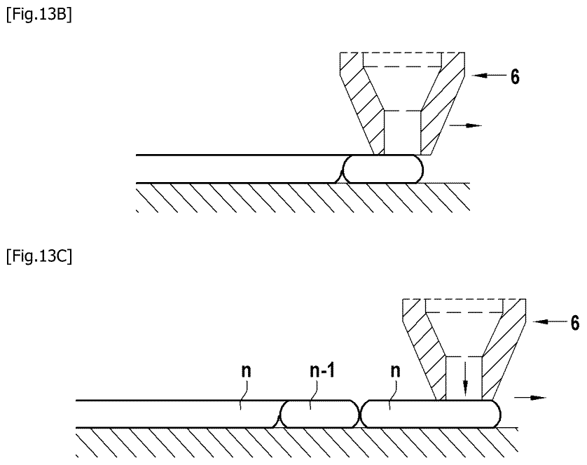

The method in accordance with the invention aims to determine whether the manipulable three-dimensional green structure comprises a wall whose width is equal to or greater than the nominal width L of the material deposition. Indeed, for a wall whose width is equal to the nominal width L of the material deposition, this wall is constructed with the aid of material depositions only superimposed without creating material voids. For this type of wall, it should be noted that the superposed deposition of beads of material does not lead to the creation of material voids except in the case where the trajectory comprises a path with a crossing as appears in relation to FIGS. 6 and 13A to 13E.

As shown in FIG. 6, a path with crossing appears for a figure eight-shaped structure. A crossing appears when the trajectory, looping on itself, returns to the point I of coordinates Xi, Yi where a material deposition (of order n−1) has already been deposited. The passing over of a material deposition (order n−1) is done by coming to touch, by the material deposition in progress (order n), the material deposition previously carried out (FIG. 13A). The extrusion of the material is then stopped (FIG. 13B) by gliding at the same altitude and resuming extrusion after the downstream edge of the material deposition of order n−1 (FIG. 13C). The material deposition of order n+1 superimposes the material deposition of order n−1 and the passing over of this new material deposition is carried out as described above (FIGS. 13D and 13E). As can be seen clearly in the figures, the juxtaposition or joining of two material depositions during the complete passing over of a previously deposited material deposition leads to the creation of voids.

FIGS. 3 and 3A illustrate a first variant embodiment, known as the conventional mode, for producing a wall 10 whose width is equal to the nominal width L of the material deposition. By way of example, this wall 10 forms part of a manipulable three-dimensional green structure in the form of a support of circular cross-section having a single central channel 11. The trajectory of the extrusion head 6 is broken down into circular paths of mean diameter D, each of a length nD and with an elevation of the extrusion head along the vertical axis by increments e at each turn. The extrusion head 6 carries out a first turn t while being positioned at an elevation e with regard to the level of the plate 5, so that it extrudes a constant quantity of material in order to produce a material deposition of constant thickness e. By way of example, the arrow F indicates here the counterclockwise direction of movement of the extrusion head 6. Once the first turn t has been carried out, the extrusion head 6 rises by a value equal to the thickness e of the material deposition in order to produce a second turn while extruding a constant quantity of material in order to deposit the material continuously. The material depositions 3 are carried out in this manner until the desired height is obtained.

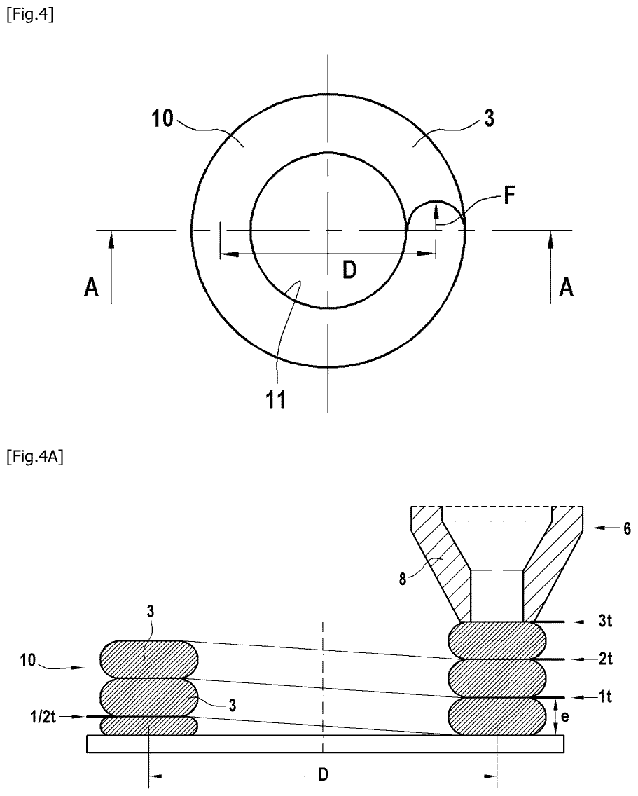

FIGS. 4 and 4A illustrate a second variant embodiment called the vase mode for producing a wall 10 in the case, for example, of a manipulable three-dimensional green structure in the form of a support of circular cross-section having a single central channel 11. The trajectory of the extrusion head 6 is broken down into circular paths of mean diameter D, each of which is equal to nD, with the extrusion head raised along the vertical axis by a succession of increments so that at the end of each turn, the sum of these increments makes it possible to obtain, at each turn, a material deposition of thickness e.

During the first turn t, the extrusion head extrudes an increasing quantity of material proportional to its position on the mean slope e/nD. Once the first turn t has been carried out, the extrusion head 6 makes its second turn following the same mean slope e/nD and extruding a constant quantity of material in order to deposit the material continuously according to an elevation corresponding to the thickness e. The material depositions 3 are carried out in this manner until the desired height is obtained.

In the case where the manipulable three-dimensional green structure comprises a wall whose width is greater than the nominal width L of the material deposition, then the material depositions must be made in accordance with the invention since it is no longer possible to construct this wall with the aid of solely superimposed material depositions. In accordance with the invention, the method provides for entanglement of the material depositions as a result of an interleaving by overlapping(s) and/or crossing(s) of said material depositions 3 in order to avoid the creation of spaces or voids of material between the material depositions. Entanglement in the sense of the invention, independently of the definition given by quantum mechanics, is understood to mean the intertwined state of material depositions due to overlaps and/or crossings.

Thus, for a wall 10 whose width is greater than the nominal width L of the material deposition 3, the method according to the invention aims to break down the numerical trajectory of the extrusion head 6 exclusively into overlapping paths and/or crossing paths. It must be understood that the extrusion head 6 (or more precisely its carriage) follows, point by point, a trajectory completely defined from the beginning to the end of the manufacturing process of the manipulable three-dimensional green structure 2, by a succession of points. Each of these points is spatially predefined by its Cartesian coordinates Xi, Yi, Zi. Xi and Yi exactly define the position of the centre of the circular orifice 8 of the extrusion nozzle. The extrusion head 6 thus moves from a point A (Xa, Ya, Za) to a point B (Xn, Yn, Zn) following a vector AB, then from point B to a point C following the vector AC, and so on by conforming to a succession of instruction lines called G-code instructions of the intermediate software between the 3D digital model and the printing machine. It should be noted that in addition to the determination of the trajectory at each of its points determined by the Cartesian coordinates Xi, Yi, Zi, all the parameters are defined for each of these points, i.e., in particular, the extrusion flow rate E and the movement speed F of the extrusion head 6.

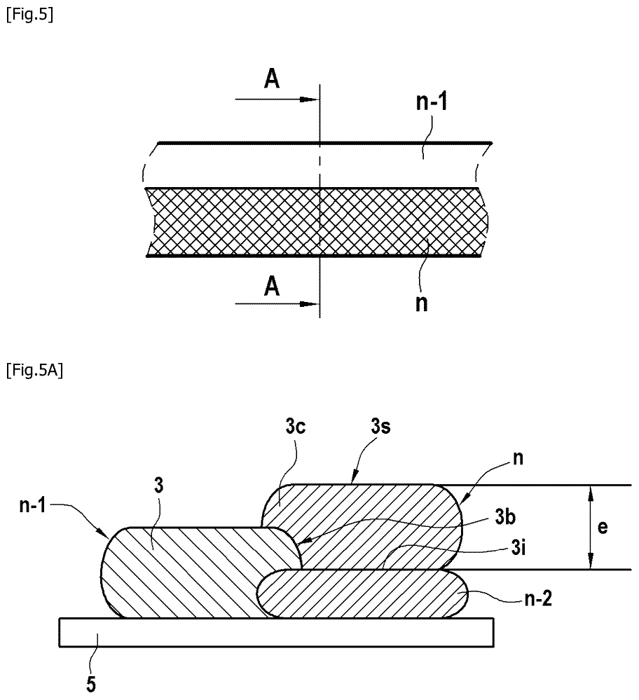

It should be understood that the numerical trajectory of the extrusion head 6 is broken down into overlapping paths and/or crossing paths. An overlapping path corresponds, as illustrated in FIGS. 5 and 5A, to a portion of the trajectory for which a material deposition 3 (of order n) partially overlaps at least one edge 3b of a material deposition 3 (of order n−1) previously deposited so as to avoid spaces in the internal part of the manipulable three-dimensional green structure between the rounded edges of the material deposition in progress and those of the material deposition previously deposited. As can be seen more specifically in FIG. 5A, the material being deposited (of order n) partially overlaps at least one edge 3b of a previously deposited material deposition (of order n−1), by an overlapping material part 3c presented in its thickness, that is to say between the upper face 3s and the lower face 3i of said deposition in progress. In addition, this overlapping material part 3c has a thickness strictly less than the nominal height e.

According to one characteristic of the method in accordance with the invention, for a path with overlap, the extrusion head 6 is driven to adjust the extrusion rate as a function of the degree of overlap of the overlapping material part on the previously deposited material deposition.

A crossing path corresponds, as illustrated in FIGS. 6A and 6B, to a part of a trajectory for which a material deposition being deposited (of order n) crosses at least one material deposition previously deposited (of order n−1), with a complete overlap of said deposition of previously deposited material so as to avoid, in the internal part of the manipulable three-dimensional green structure, spaces between the rounded edges of the material deposition in progress and those of the deposition of the previously material deposition. In a crossing path, the material being deposited (order n) completely overlaps, by an overlapping material part 3c, the previously deposited material deposition (order n−1), i.e., extending at least from one edge 3b to the other of the previously deposited material deposition. This intersection between these two material depositions can take place in any possible angle between the directions of these two material depositions. The overlapping material part 3c is considered in the thickness of the material deposition in progress, i.e. between the upper face and the lower face of said deposition in progress. In addition, this overlapping material part 3c has a thickness strictly less than the nominal height e.

The preceding description results in the interleaving of the material depositions 3. Such interleaving exists from the moment when there is in a turn, at least one overlapping path and/or one crossing path. Each of the following turns which necessarily covers the preceding overlap(s) and/or the crossing(s) creates an entanglement of the material depositions 3. The entanglement of the material depositions is thus the result of multiple turns for each of which there is at least one path with overlap and/or one path with crossing.

According to one characteristic of the method in accordance with the invention, for a path with crossing, the extrusion head 6 is driven to reduce the quantity of material deposited in order to produce the overlapping material part having a thickness strictly less than the nominal height e. Thus, as is clearly apparent in FIGS. 6A and 6B, each material deposition has a nominal height e except at right angles to or when passing over a material deposition already made.

Thus, in the example illustrated in FIGS. 6A and 6B, a first material deposition n is made with a thickness less than the nominal height e, for example equal to e/2. For a material deposition n which crosses the material deposition n−1 previously made, this material deposition n is made with a nominal thickness e except when it overlaps the preceding material deposition n−1. When the extrusion head overhangs the material deposition, the extrusion rate is reduced so that the overlapping part 3d of the deposition has a thickness less than the nominal thickness e, equal to e/2 in the example illustrated. In this way, the crossing paths produced according to the principle of the invention do not have voids of material, unlike in the prior art, as illustrated in FIGS. 13C to 13E.

According to a preferred embodiment of the invention, the extrusion head 6 is mounted moveably along the predefined numerical trajectory T in order to carry out a succession of turns t each corresponding to the path travelled in order to find the same position in the horizontal plane with an elevation corresponding to a nominal height e. In other words, the numerical trajectory of the extrusion head 6 is broken down into turns, considering that for each turn, the extrusion head rises by the nominal height e. Of course, the number of turns t is chosen in order to obtain the desired height for the manipulable three-dimensional green structure 2.

In each of these turns t, the course of the extrusion head 6 is one or more overlapping paths and/or one or more crossing paths. For each of these turns, the extrusion head 6 follows a course formed by a succession of points of coordinates Xi, Yi, Zi as explained above, with the possibility of elevation along the vertical axis, on one or more of these points.

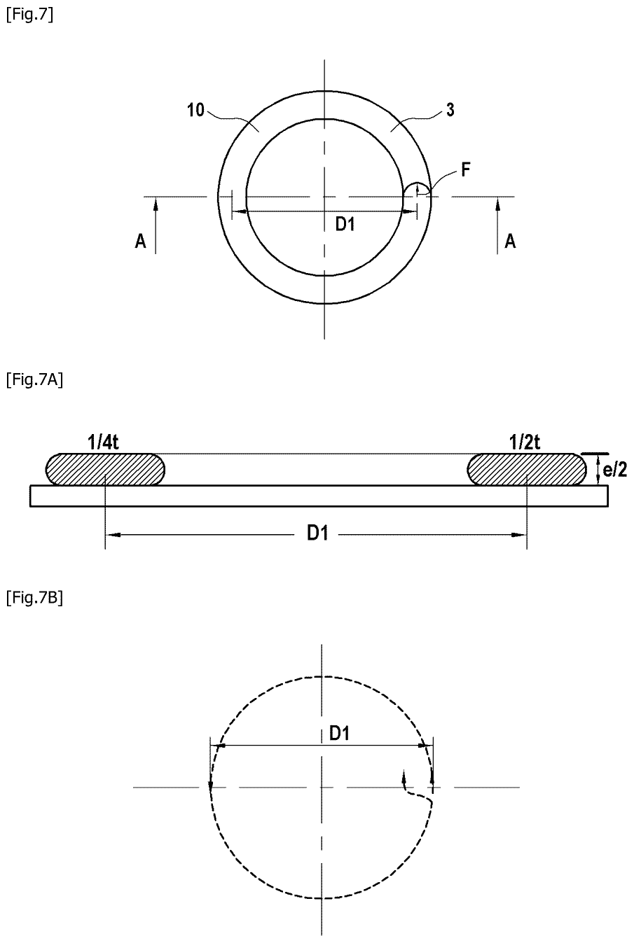

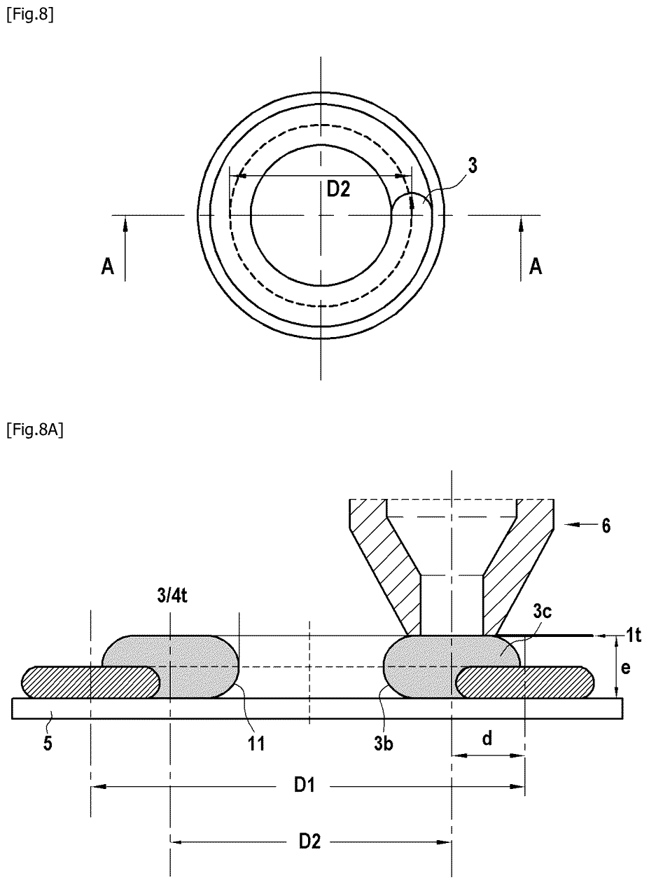

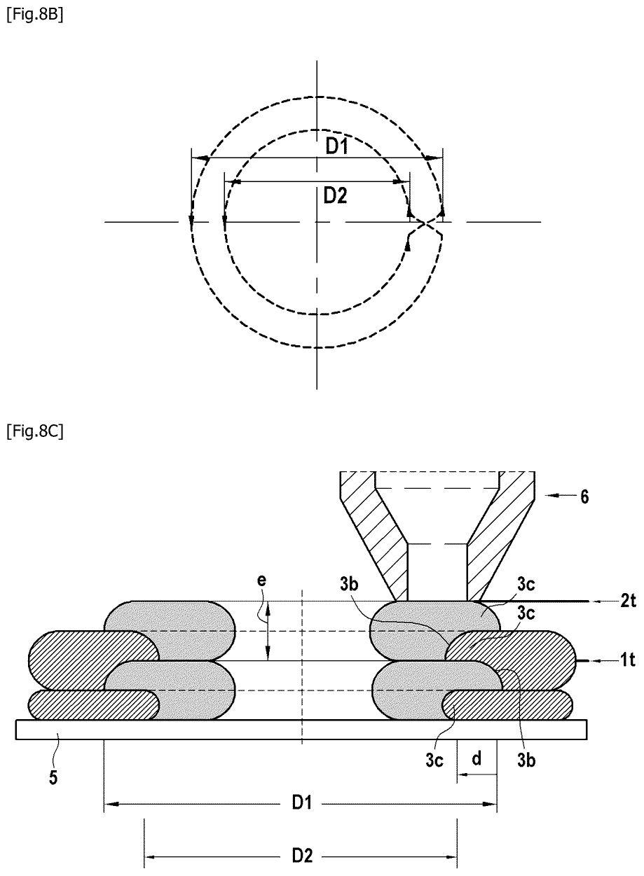

According to a first example of embodiment described more precisely in relation to FIGS. 7 to 7B and 8 to 8C, the method provides for driving the extrusion head 6 so that on at least one turn, the extrusion head rises at least once from an intermediate height which is a fraction of the nominal height e.

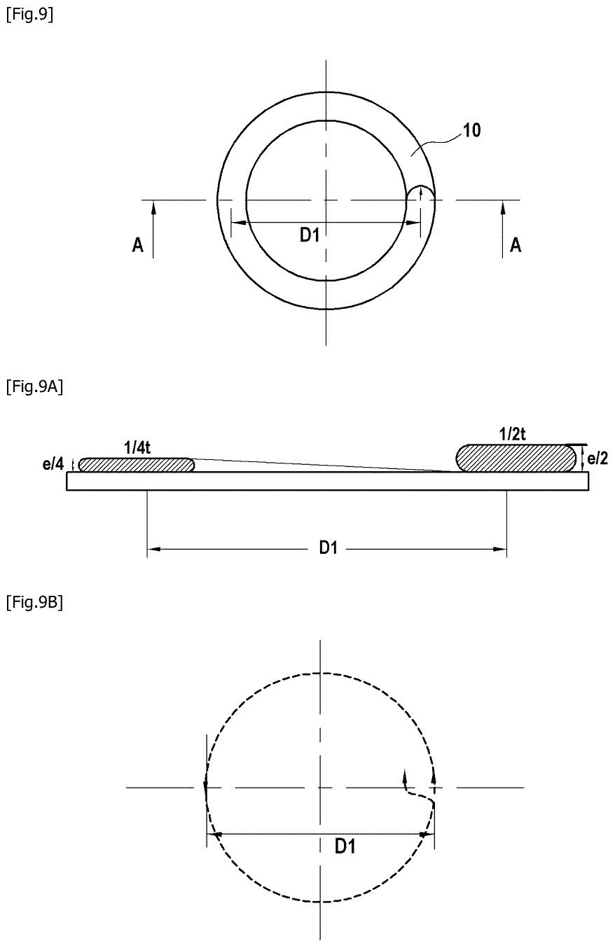

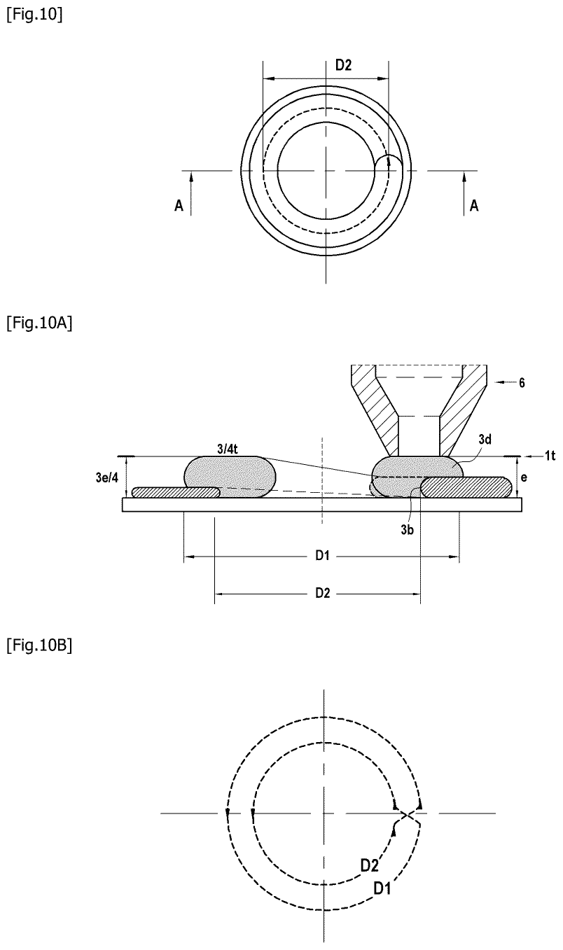

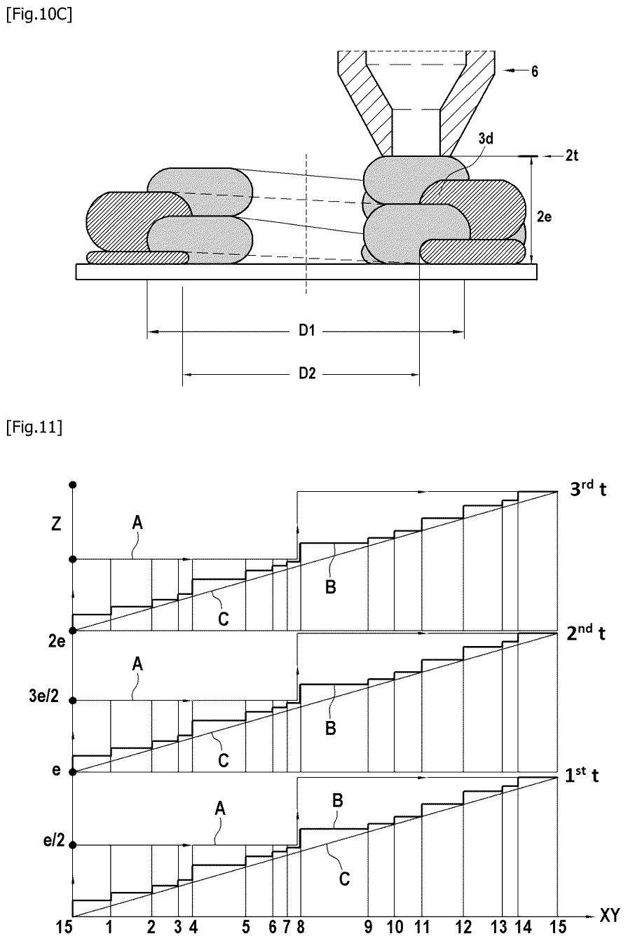

According to a second example of embodiment described more precisely in relation to FIGS. 9 to 9B and 10 to 10C, the method provides for driving the extrusion head 6 so that on at least one turn, the extrusion head is positioned at different points of the path, rising at each point by a height increment whose sum corresponds to the nominal height e.

The following description, in relation to FIGS. 7 to 7B and 8 to 8C, describes the first example of embodiment of the method called “sequential vase mode” consisting in constructing a part of the path at the same altitude a (for example a=e/2) then incrementing in elevation by a value a in order to complete the turn and overlap the previous deposition of an overlapping part of material of value a. According to this method, the nominal height e is an integer multiple of a.

FIG. 7B shows the first half of the path to be travelled by the extrusion head corresponding to a circle of diameter D1. As illustrated in FIGS. 7 and 7A, a first bead of material 3 is deposited on the horizontal plate 5 with an elevation equal to e/2 continuous over the entire course of the circle of diameter D1. In the sense of the invention, this course, which covers a circumference of 360°, corresponds to a half-turn. Once this half-turn has been covered at the same altitude e/2, the extrusion head 6 and therefore the centre of the flow orifice 8 moves radially toward the centre of the circle by a distance equal to d=(D2−D1)/2 and rises by an equal increment e/2 following a circle of diameter D2 (FIGS. 8A, 8B). This results in a material deposition which partially overlaps the inner edge 3b of the material deposition previously deposited, by an overlapping material part 3c presented in its thickness. It should be noted that the overlapping material part 3c has a thickness strictly less than the nominal height e. The extrusion head 6 has thus travelled a turn t in the sense of the invention corresponding to the path with the circle of diameter D1 followed by the circle of diameter D2 (FIG. 8B).

In the position illustrated in FIG. 8A, the extrusion head 6 (and thus the centre of the flow orifice 8) is offset radially outwards from circle D2 by a distance equal to d and rises again by an increment e/2 so as to partially overlap the previous material deposition along circle D1. This results in a material deposition which partially overlaps the outer edge 3b of the material deposition previously deposited, by an overlapping material part 3d presented in its thickness. The overlapping material part 3d has a thickness strictly less than the nominal height e. The extrusion head 6 is offset radially inwards from circle D1 by a distance equal to d and rises again by an increment e/2 so as to partially overlap the previous material deposition along circle D2. This results in a material deposition which partially overlaps the inner edge 3b of the material deposition previously deposited, by an overlapping material part 3c presented in its thickness. The extrusion head 6 has thus travelled a second turn t in the sense of the invention corresponding to the path with the circle of diameter D1 followed by the circle of diameter D2 (FIG. 8C).

The extrusion head 6 is thus driven in accordance with a number of turns allowing the construction according to the desired height for the manipulable three-dimensional green structure 2. It should be noted that in the example illustrated, the courses according to the first turn and the second turn are identical. Of course, it can be envisaged that the courses of the different turns are different from each other. Similarly, the nominal height e for each of the turns, which is identical in the example illustrated, may be different for the different turns.

The following description, in relation to FIGS. 9 to 9B and 10 to 10C, describes the second example of implementation of the method called the “continuous vase mode” for which the extrusion head 6 extrudes an increasing quantity of material proportional to its position.

FIG. 9B shows the first half of the path to be travelled by the extrusion head corresponding to a circle of diameter D1. As illustrated in FIGS. 9 and 9A, a first bead of material is deposited on the horizontal plate 5 with a continuous progressive rise along the entire course of the circle of diameter D1 to reach, at the end of the course of circle D1, a height equal to e/2. In the sense of the invention, this course corresponds to a half-turn and it should be noted that at a quarter-turn, the thickness of the material deposition is equal to e/4. Once this half-turn is completed to reach altitude e/2, the extrusion head 6 is displaced radially toward the centre of the circle by a distance equal to D=(D2-D1)/2 and rises progressively and continuously following a circle of diameter D1 to reach the altitude e at the end of the path travelled along this diameter D1 (FIGS. 10, 10A, 10B). This results in a material deposition which partially overlaps the inner edge 3b of the material deposition previously deposited, by an overlapping material part 3d presented in its thickness. It should be noted that the overlapping material part has a thickness strictly less than the nominal height e. The extrusion head 6 has thus travelled a turn t in the sense of the invention corresponding to the path with the circle of diameter D1 followed by the circle of diameter D2.

In the position illustrated in FIG. 10A, the extrusion head 6 is offset radially toward the outside of the circle D2 by a distance equal to d and gradually rises by an increment e/2 so as to partially overlap the preceding material deposition along the circle D1. This results in a material deposition which partially overlaps the outer edge 3b of the material deposition previously deposited, by an overlapping material part 3d presented in its thickness. The overlapping material part has a thickness strictly less than the nominal height e. The extrusion head 6 is offset radially inwards from circle D1 by a distance equal to d and gradually rises again by an increment e/2 so as to partially overlap the previous material deposition along circle D2. This results in a material deposition which partially overlaps the inner edge of the material deposition previously deposited, by an overlapping material part presented in its thickness. The extrusion head has thus travelled a second turn t in the sense of the invention corresponding to the path with the circle of diameter D1 followed by the circle of diameter D2 (FIG. 10C).

The extrusion head 6 is thus driven in accordance with a number of turns allowing the construction according to the desired height for the manipulable three-dimensional green structure. It should be noted that in the example illustrated, the courses according to the first turn and the second turn are identical. Of course, it can be envisaged that the courses of the different turns are different from each other. Similarly, the nominal height for each of the turns, which is identical in the example illustrated, may be different for the different turns.

By way of example, FIG. 11 illustrates, by curve A, the course of the extrusion head 6 for the process called “sequential vase mode” described in relation to FIGS. 7 to 7B and 8 to 8C. The path is traversed, for example, from point to point by two steps of increments e/2. According to this example, the extrusion head 6 is driven so that, over at least one turn t, the extrusion head rises at least once by an intermediate height which is a fraction of the nominal height.

Curve B describes the course of the extrusion head 6 for the process called “continuous vase mode” illustrated by FIGS. 9 to 9B and 10 to 10C. In the example illustrated, each path (one turn t) is travelled along fifteen points (coordinates in X, Y), that is to say with fifteen increments or steps of height dZ proportional to the distance between two successive points, i.e., fifteen increments of equal height dZ=e/15. The method thus aims to drive the extrusion head 6 so that, over at least one turn, the extrusion head is positioned at different points of the path, rising at each point by a height increment whose sum corresponds to the nominal height e. It should be noted that FIG. 11 shows the continuous progressive elevation curve C corresponding to the progressive elevation along the Z axis of the extrusion head.

It results from the previous description that the extrusion head 6 is driven so that by the succession of turns, the extrusion head rises to build the manipulable three-dimensional green structure in accordance with the 3D digital model, following a trajectory with an uninterrupted material deposition 3 from the beginning to the end of the construction of the manipulable three-dimensional green structure 2.

Moreover, the extrusion head 6 is driven so that, during each turn t, the extrusion head is offset in the horizontal plane X, Y so that the material being deposited partially overlaps an edge of a material deposition previously deposited. Advantageously, for an overlapping path, the extrusion head 6 is driven to adjust its position in the horizontal plane X, Y to define the degree of overlap of the overlapping material part 3d on the previously deposited material deposition. As described above, the offset d in the horizontal plane X, Y between the consecutive courses makes it possible to choose the degree of overlap between the material depositions.

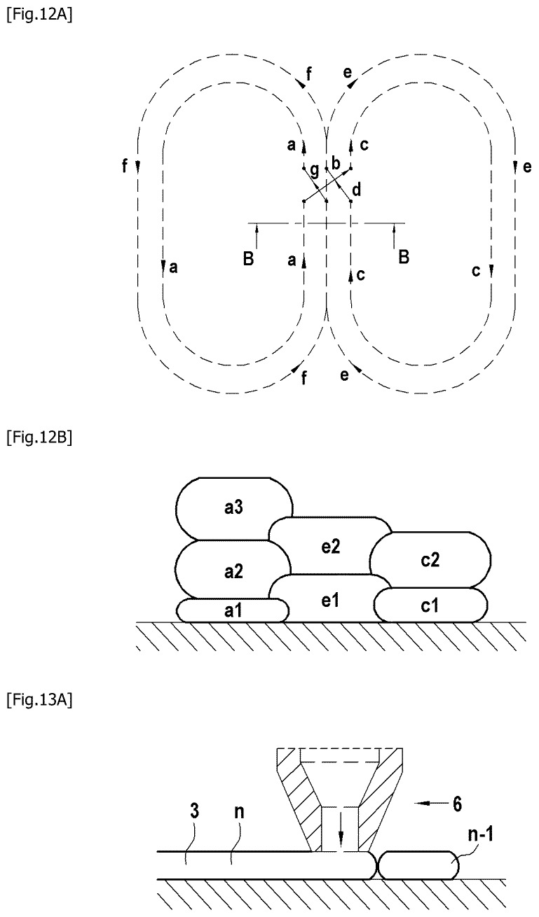

In the examples of embodiment illustrating the principle of the invention, it should be noted that the wall to be constructed has a width that can be constructed from two partially overlapping material depositions. Of course, the principle of the invention can be implemented to construct a wall whose width requires a greater number of material depositions as illustrated by way of example in FIGS. 12A and 12B with three deposits. According to this example of embodiment, the wall to be constructed delimits two contiguous channels and has a width with overlapping of three deposits. The construction of this wall is obtained in vase mode by following the path a1+b1+c1+d1+e1+f1+g1 then the path a2+b2+c2+d2+e2+f2+g2 then a3+b3+ etc. The flow rate of the extrusion head 6 has fallen to zero when the extrusion head 6, completing fi, joins ei until the bifurcation (following gi) to join ai+1. The thicknesses of the material depositions from the first turn are proportional to the path travelled, while the thicknesses of the material depositions from the second turn are equal to the nominal thickness.

According to a characteristic of implementation of the invention, it should be noted that for a path with overlap, the extrusion head 6 is driven to keep the flow rate of deposited material constant while the flow rate of the extrusion head 6 is reduced for a path with crossing.

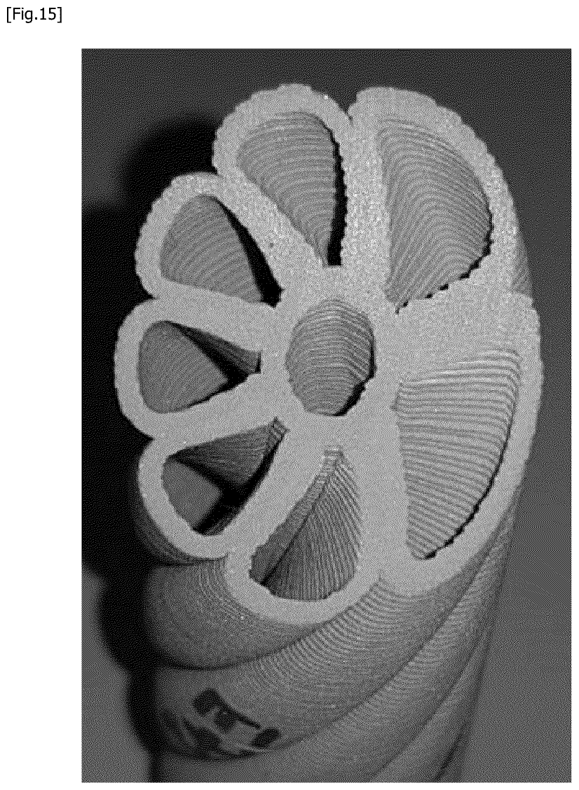

The method according to the invention thus makes it possible to construct a manipulable three-dimensional green structure 2 without creating material voids, regardless of the shape or dimensions of the walls. FIG. 15 illustrates an example of a manipulable three-dimensional green structure 2 which, after sintering, has no material voids in the walls produced. The examples described above explain a first advantageous variant of the embodiment known as the conventional mode or the vase mode for which the extrusion head follows a trajectory with an uninterrupted material deposition 3 from the beginning to the end of the construction of the manipulable three-dimensional green structure 2.

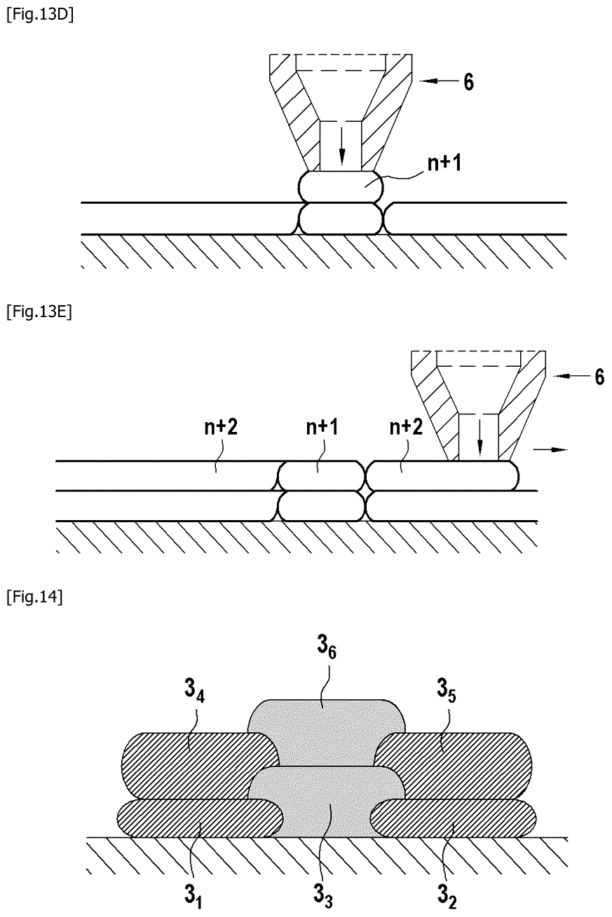

FIG. 14 illustrates a second variant embodiment for which the extrusion head 6 is mounted moveably along the predefined numerical trajectory T in order to effect superimposed material depositions in strata, each rising by a nominal height e. The material deposition by strata is especially described by patent applications WO 2020/109715 and WO2020/109716. This method consists in forming a first stratum 3₁ and 3₂, according to the 3D digital model M predetermined by computer design software, by virtue of the horizontal movement of the flow orifice 8 above the horizontal plate 5.

The extrusion head 6 moves horizontally, and therefore parallel to the horizontal plate 5, along a predetermined path according to the 3D digital model M, to form the first stratum. After depositing the first stratum, the extrusion head 6 moves so that the deposited bead forms the second stratum 3₃ in accordance with the 3D digital model M. For this purpose, the extrusion head 6 moves vertically (i.e., along the Z axis) and horizontally (i.e., along the X and/or Y axes) to the desired position. The extrusion of the inorganic composition 4 through the extrusion head 6 may be continuous or discontinuous. Thus, the second stratum is deposited on the first stratum by superposing the material deposition on the previously deposited stratum, in accordance with the 3D digital model M.

Of course, the material deposition is carried out to ensure an overlap (partial or complete) as described above in order to avoid the creation of voids between the material depositions. Thus, in the example illustrated in FIG. 14, the material deposition 3₃ of the second stratum partially overlaps from its two opposite edges, the adjacent edges of two previously deposited material depositions 3₁ and 3₂, making it possible to avoid the creation of voids.

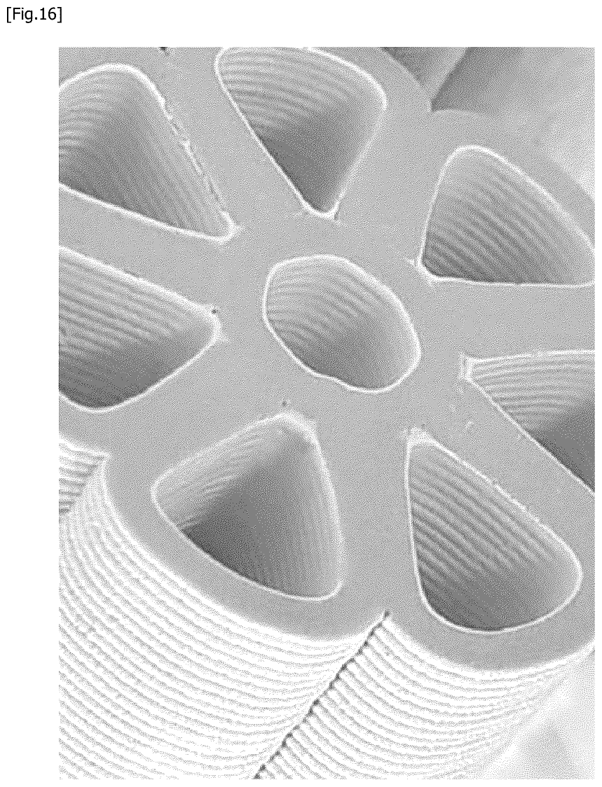

The method according to the invention makes it possible to construct manipulable three-dimensional green structures 2 intended to form monolithic porous inorganic supports 1, having mechanical strength characteristics suitable for their use in tangential filtration. Advantageously, the extrusion head 6 is driven so as to provide at least one channel 11 for circulating a fluid medium to be treated in the manipulable three-dimensional green structure 2. The wall of this channel 11 is formed by the rounded edges 3b of the material depositions situated opposite the overlapping part of material. As illustrated in the drawings, the extrusion head 6 is configured so that the material depositions have rounded edges 3b. Thus, a channel 11 has a wall having rounded reliefs each extending over the entire periphery of the channel and being defined by the rounded edge 3b of the material depositions. These rounded perimeter reliefs extend superimposed over the length of the channel as illustrated in FIGS. 15 and 16. At the scale of the thickness of the material depositions e, these rounded perimeter reliefs contribute at their level, in this channel, in tangential filtration, to the generation of turbulence all along the channel. FIG. 16 shows that these rounded perimeter reliefs are present even when the inner wall of the channels 11 is coated with separating layers whose profile appears in the form of a white line in FIG. 16. The separating layer or layers thus match the rounded perimetric reliefs whose rounded profile persists to participate in the creation of turbulence in the channel 11. It should be noted that the porous monolithic inorganic support 1 manufactured according to the method in accordance with the invention has an outer surface also having a succession of rounded perimeter reliefs St which extend superposed along the support, as illustrated in FIGS. 2B, 15 and 16.

1. A method for the production of at least one porous monolithic inorganic support (1) having at least one channel for circulating the fluid to be treated and having a porosity comprised between 10% and 60% and a mean pore diameter ranging from 0.5 μm to 50 μm, by means of a 3D printing machine (I) comprising at least one extrusion head (6) mounted moveably in space above a fixed horizontal plate (5), by being successively moved with a nominal height (e) along a predefined numerical trajectory (T) to effect superimposed material depositions each having a nominal width and a defined thickness between a lower surface and an upper surface, said 3D printing machine allowing depositing material in the form of:
a bead with rounded edges so as to create rounded perimeter reliefs participating in the generation of turbulence on the wall of at least one circulation channel,
a composition (4) to build, on said horizontal plate (5), from the predefined numerical trajectory (T), walls of a manipulable three-dimensional green structure (2) to form the monolithic porous inorganic support(s) (1), the method consisting of:
For a wall whose width is greater than the nominal width (L) of the material deposition, to break down the numerical trajectory exclusively into overlapping paths and crossing paths;
To supply the extrusion head (6) of the 3D printing machine (I) with a composition (4),
To drive the extrusion head according to the numerical trajectory so that:
for an overlapping path, the material being deposited partially overlaps at least one edge of a previously deposited material deposition, by an overlapping material part presented in its thickness and having a thickness strictly less than the nominal height (e) so as to avoid, in the inner part of the manipulable three-dimensional green structure, spaces between the rounded edges of the material deposition being deposited and those of the material deposition previously deposited,
for a crossing path, the material being deposited intersects at least one previously deposited material deposition with a complete overlap of said previously deposited material deposition, by an overlapping material part presented in its thickness and having a thickness strictly less than the nominal height (e) so as to avoid, in the inner part of the manipulable three-dimensional green structure, spaces between the rounded edges of the material deposition being deposited and those of the material deposition previously deposited.

2. The method according to claim 1, according to which the extrusion head (6) is mounted moveably along the predefined numerical trajectory (T) in order to carry out a succession of turns each corresponding to the path travelled in order to find the same position in the horizontal plane with an elevation corresponding to a nominal height (e_{N}).

3. The method according to claim 2, according to which the extrusion head is driven so that, over at least one turn, the extrusion head rises at least once by an intermediate height which is a fraction of the nominal height.

4. The method according to claim 2, according to which the extrusion head is driven so that, over at least one turn, the extrusion head is positioned at different points of the path, rising at each point by a height increment, the sum of which corresponds to the nominal height.

5. The method according to claim 2, according to which the extrusion head is driven so that by the succession of turns, the extrusion head rises to build the manipulable three-dimensional green structure (2) in accordance with the 3D digital model (M), following a trajectory with an uninterrupted material deposition (3) from the beginning to the end of the construction of the manipulable three-dimensional green structure (2).

6. The method according to claim 2, according to which the extrusion head is driven so that, during each turn, the extrusion head is offset in the horizontal plane so that the material being deposited partially overlaps an edge of a deposition of previously deposited material.

7. The method according to claim 1, according to which, for a crossing path, the extrusion head is driven to reduce the quantity of material deposited to produce the overlapping material part having a thickness strictly less than the nominal height (e_{N}).

8. The method according to claim 1, according to which, for a path with the same overlap, the extrusion head is driven to keep the flow rate of deposited material constant.

9. The method according to claim 1, according to which, for an overlapping path, the extrusion head is driven to adjust its position in the plane to define the degree of overlap of the overlapping material part on the previously deposited material deposition.

10. The method according to claim 1, according to which, for an overlapping path, the flow rate of the extrusion head is adjusted according to the degree of overlap of the overlapping material part on the previously deposited material deposition.

11. The method according to claim 1, according to which the extrusion head (6) is mounted moveably along the predefined numerical trajectory (T) in order to carry out superimposed material depositions in strata each rising by a nominal height (e).

12. The method according to claim 1, according to which the extrusion head is driven so as to provide in the manipulable three-dimensional green structure (2), at least one channel for circulating a fluid medium to be treated, possessing a wall having a succession of rounded reliefs generating variations in the passage section of the channel, these rounded reliefs being formed by the part of material situated opposite the overlapping material part.

13. The method according to claim 1, according to which the extrusion head is configured so that the part of the material located opposite the overlapping material part has a rounded edge.

14. The method according to claim 1, according to which the manipulable three-dimensional green structure (2) is placed in a heat treatment furnace in order to carry out a sintering operation.

15. A method for the preparation of a tangential filtration membrane comprising the manufacture according to claim 1 of a porous monolithic inorganic support (1) in which is provided at least one channel (11) for circulating the fluid medium to be treated, followed, after the sintering of said support, by a step of creating at least one separating layer on the walls of the channel or channels (11).

16. A porous monolithic inorganic support (1) manufactured according to claim 1, having a porosity comprised between 10% and 60% and a mean pore diameter ranging from 0.5 μm to 50 μm, said porous monolithic inorganic support possessing an outer surface having a succession of rounded perimeter reliefs (st) and at least one channel for circulating the fluid to be treated whose wall has rounded perimeter reliefs participating in the generation of turbulence.

17. A tangential filtration membrane comprising a porous monolithic inorganic support (1) according to claim 16, provided with at least one channel (11) for circulating the fluid medium to be treated, whose wall with rounded perimeter reliefs is coated with at least one separating layer.

18. A tangential filtration membrane according to claim 17, wherein the creation of turbulence generated by rounded perimeter reliefs inside the channel remains after the deposit of one or more separating layer(s).
